(19) United States
(12) Patent Application Publication
(10) Pub. No.: US 2011/0193474 A1
(43) Pub. Date: Aug. 11, 2011

(54) PLASMA DISPLAY PANEL

(76) Inventors: Osamu Inoue, Osaka (JP); Hiroshi Asano, Osaka (JP); Yayoi Okui, Osaka (JP); Kojiro Okuyama, Nara (JP); Seigo Shiraishi, Osaka (JP)

(21) Appl. No.: 13/125,282

(22) PCT Filed: Jan. 14, 2010
(86) PCT No.: PCT/JP2010/000162

§ 371 Date: Apr. 20, 2011

(30) Foreign Application Priority Data
Jun. 2, 2009 (JP) 2009-026006 2009

(51) Int. Cl. H01J 1/62

(52) U.S. Cl. 313/484

(57) ABSTRACT

A material suitable for improving the secondary electron emission coefficient of PDPs is provided to thereby enable a PDP to operate at a higher efficiency. Provided is a PDP (200) which includes a protective layer (7) formed by MgO and electron-emitting particles constituted of a crystalline compound dispersed on the protective layer (7) to form an electron emission layer (20). The electron-emitting particles are a crystalline compound whose primary components are indium, oxygen, and one or more selected from the group consisting of calcium, strontium, barium, and rare earth metals.

### TECHNICAL FIELD

The present invention relates to plasma display panels.

### BACKGROUND ART

Plasma display panels (hereinafter, abbreviated as PDPs) have been commercialized and have rapidly become popular as flat-screen display panels that can easily be made in large sizes, are capable of high speed display, and are low cost.

A typical PDP that has presently been commercialized has a structure in which a front and a back glass substrate are disposed to oppose each other, pairs of electrodes are arranged in a regular manner on the substrates, and a dielectric layer made, for example, of a low melting glass is formed on each substrate so as to cover the electrodes. A phosphor layer is provided on a dielectric layer formed on the back substrate. On the dielectric layer formed on the front substrate, an MgO layer is provided as a protective layer for protecting the dielectric layer from ion bombardment and improving secondary electron emission. A gas mainly composed of inert gases such as Ne, Xe, etc. is then injected between the two substrates.

This type of PDP displays images by applying voltage between electrodes, thus producing a discharge that causes phosphors to emit light.

There has been a strong demand to improve luminous efficiency in conventional PDPs. Known methods to do so include a method of lowering the dielectric constant of the dielectric layer and a method of increasing partial pressure of Xe in the discharge gas. Use of such methods, however, gives rise to a problematic increase in firing voltage and sustaining voltage.

To address this problem, it is known that the firing voltage and the sustaining voltage can be lowered and efficiency improved by using a material with a high secondary electron emission coefficient for the protective layer, and that costs can be lowered by using an element with low pressure resistance.

For example, Patent Literature 1 and 2 recite an alkaline earth metal oxide as a substitute for MgO. Formation of the protective layer with CaO, SrO, and BaO, which have a higher secondary electron emission coefficient, or with a solid solution of a compound thereof, is being examined.
Patent Literature 1: Japanese Patent Application Publication No. 52-63663
Patent Literature 2: Japanese Patent Application Publication No. 2007-95436

### SUMMARY OF INVENTION

### Technical Problem

CaO, SrO, BaO, and the like, however, are less chemically stable than MgO, and thus readily react with moisture and carbon dioxide in the air to produce hydroxide and carbonate, respectively. When such compounds are produced, firing voltage and sustaining voltage cannot be lowered as intended due to reduction of the secondary electron emission coefficient of the protective layer. Furthermore, the aging processing required to reduce voltage becomes extremely long. The use of CaO, SrO, BaO, and the like is therefore impractical.

While rare earth metal oxides such as La₂O₃ normally have a high secondary electron emission coefficient, they too are chemically unstable as are CaO and the like. Such rare earth metal oxides are also therefore impractical for use in the protective layer.

When a small number of PDPs are produced on a laboratory scale, such degradation due to chemical reaction of CaO, SrO, BaO, etc. is avoidable by controlling operation. In a manufacturing plant, however, it is difficult to actually control atmosphere during the whole process. Even if such control were possible, it would lead to high costs.

Therefore, although the use of a material with a high secondary electron emission coefficient has been considered, only MgO is in practical use as a material for the protective layer.

The present invention has been achieved in view of the above problems, and it is an object thereof to improve efficiency of a PDP by providing a material appropriate for improving the secondary electron emission coefficient of the PDP.

### Solution to Problem

The present invention is a PDP that causes discharge in a discharge space by applying voltage between electrodes and causes phosphors to emit visible light by the discharge, wherein a region facing the discharge space has disposed thereon a compound whose primary components are In, O, and one or more selected from the group consisting of Ca, Sr, Ba, and a rare earth metal.

In this context, the “region facing the discharge space” is a region exposed to charged particles and the like produced by the discharge in the discharge space. Specifically, the region corresponds principally to the surface of the protective layer, the surface of the phosphor layer, and the surface of the barrier ribs. The region also corresponds to the inside of the protective layer, the inside of the phosphor layer, and the inside of the barrier ribs.

The compound is preferably a crystalline material. Specifically, the crystalline material is preferably one or more selected from the group consisting of (i) MIn₂O₄, M being one or more selected from the group consisting of Ca, Sr, and Ba, (ii) MInO₃, M being one or more rare earth metal, (iii) (M1₁₋ₓM2ₓ)InO₃₋δ, M1 being one or more rare earth metal, and M2 being one or more selected from the group consisting of Sr and Ca, and (iv) M1(In_{1/2}M2_{1/2})O₃, M1 being one or more selected from the group consisting of Ca, Sr, and Ba, and M2 being one or more selected from the group consisting of Nb and Ta. δ represents the amount of oxygen deficiency and is a value smaller than one.

### Advantageous Effects of Invention

As described in detail in the Embodiments, a compound whose primary components are In, O, and one or more selected from the group consisting of Ca, Sr, Ba, and a rare earth metal is chemically stable and has a high secondary electron emission coefficient. Accordingly, disposing this compound in a region facing the discharge space in the PDP is a practical way of reducing the driving voltage of the PDP.

Furthermore, using an MgO film, which shows high resistance to ion bombardment, for the protective layer as in a conventional PDP and using the above compound as an electron emissive material achieves a long-lasting PDP with low driving voltage.

### BRIEF DESCRIPTION OF DRAWINGS

FIG. 1 is a perspective view of a PDP according to Embodiment 1 of the present invention.

FIG. 2 is a longitudinal sectional view of the PDP shown in FIG. 1.

FIG. 3 is a perspective view of a PDP according to Embodiment 2 of the present invention.

FIG. 4 is a longitudinal sectional view of the PDP shown in FIG. 3.

### DESCRIPTION OF EMBODIMENTS

First, the electron emission material used in the PDP of the present invention is described.

After a detailed examination, the inventors found that, without a significant decrease in secondary electron emission efficiency, it is possible to increase chemical stability by reacting CaO, SrO, BaO, and rare earth metal oxides, which have a high secondary electron emission efficiency but are chemically unstable, with In₂O₃, yielding a compound including In, O, and one or more selected from the group of Ca, Sr, Ba, and a rare earth. The inventors also found that using this electron emission material in the protective layer of a PDP reduces driving voltage as compared to a PDP having a protective layer only of MgO.

### (Composition of Electron Emission Material)

The electron emission material used in the PDP of the present invention is a compound having, as primary components, In, O, and one or more selected from the group consisting of Ca, Sr, Ba, and a rare earth metal.

This compound may be amorphous, but to further improve stability, it is preferable that the compound be crystalline.

Preferable crystalline compounds fundamentally include MIn₂O₄, M being one or more selected from the group consisting of Ca, Sr, and Ba; MInO₃, M being one or more rare earth metal; (M1₁₋ₓM2ₓ)InO₃-δ, M1 being one or more rare earth metal, and M2 being one or more selected from the group consisting of Sr and Ca; and M1 (In_{1/2}M2_{1/2})O₃, M1 being one or more selected from the group consisting of Ca, Sr, and Ba, and M2 being one or more selected from the group consisting of Nb and Ta.

The secondary electron emission efficiency of these crystalline compounds increases in the following order: a compound including a rare earth metal oxide, a compound including CaO, a compound including SrO, and a compound including BaO. However, the chemical stability of the compounds decreases in this order.

Required chemical stability varies depending on process conditions during actual manufacturing of a PDP. Therefore, it is difficult to make a general determination of which compound is best. Among these compounds, however, SrIn₂O₄ is preferable, as this compound has a high secondary electron emission coefficient and chemically is highly stable.

### (Method of Synthesizing Electron Emission Material)

Methods of synthesizing a compound whose primary components are In, O, and one or more selected from the group consisting of Ca, Sr, Ba, and a rare earth metal include a solid phase method, a liquid phase method, and a gas phase method.

In the solid phase method, base powders including each metal (e.g. a metal oxide, metal carbonate, etc.) are mixed and reacted by heat treatment at a certain temperature or higher.

In the liquid phase method, a solid phase is precipitated in a solution including each metal, or the solution is applied to a substrate, dried, heat-treated at a certain temperature or higher, etc. to form a solid phase.

The gas phase method is, for example, deposition, sputtering, or CVD. A membranous solid phase can be obtained with this method.

With the gas phase method, it is possible to achieve not only a crystalline oxide in which the above-described Ca, Sr, Ba, rare earth metal, and In are in specific proportions, but also an amorphous compound whose primary components are In, O, and one or more selected from the group consisting of Ca, Sr, Ba, and a rare earth metal.

This amorphous film is also chemically stable as compared to CaO, SrO, BaO, and rare earth metal oxides and has higher secondary electron emission efficiency than MgO, allowing for a reduction of driving voltage of the PDP. However, the crystalline compound is chemically more stable, and the gas phase method is more expensive than other methods of synthesis such as the solid phase method. Therefore, the crystalline compound is preferable.

(Form of Electron Emission Material and Location where Disposed)

The above-described electron emission material should be disposed within the PDP panel at least in a region facing the discharge space, generally on the dielectric layer covering electrodes on the front substrate.

As long as at least part of the electron emission material is disposed on a region facing the discharge space, disposing the electron emission material on other locations as well, such as a phosphor part or a surface of a rib, yields further lowering of the driving voltage as compared to when the electron emission material is not disposed in such other locations.

The electron emission material may for example be formed on the dielectric layer that covers the electrodes on the front substrate. In order to do so, a film may be formed with the compound or a powder of the compound may be dispersed instead of forming an MgO film as a regular protective layer on the dielectric layer, or alternatively the film or powder of the compound may be respectively formed or dispersed on an MgO film that has been formed.

When the compound is used as a powder, particle sizes thereof may be selected to match cell sizes, for example, in a range of approximately 0.1 μm to 10 μm.

As long as the primary components of the compound are In, O, and one or more selected from the group consisting of Ca, Sr, Ba, and a rare earth metal, it is possible to replace Ca, Sr, Ba, and rare earth metals partially with other metal elements, provided that only a small amount is replaced and that the characteristics of the compound according to the present invention (chemical stability and a high secondary electron emission efficiency) are not essentially impaired.

It is difficult to make a general determination of the range of the “primary component”, which refers to the composition range necessary for secondary electron emission properties to be observed under chemically stable conditions even during displacement to another element. A general range is for 80% or greater, more preferably 90% or greater, of the total element ratio of the cationic element to be In and one or more selected from the group consisting of Ca, Sr, Ba, and a rare earth metal.

### (Structure of PDP)

A specific example of a PDP adopting the above electron emission material is described with reference to the figures.

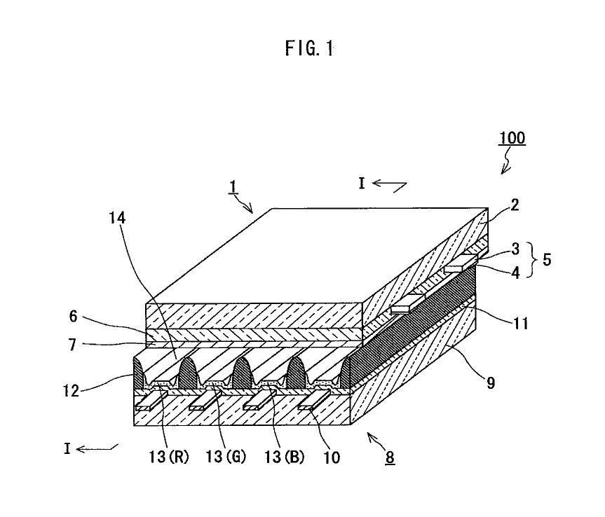

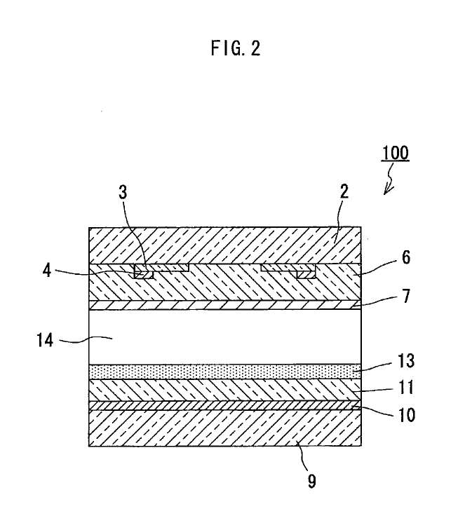

FIGS. 1 and 2 show an example of a PDP 100 according to Embodiment 1 of the present invention. FIG. 1 is an exploded perspective view of the PDP 100, and FIG. 2 is a longitudinal cross-section diagram of the PDP 100 (a cross-section diagram taken along the line I-I in FIG. 1).

As shown in FIGS. 1 and 2, the PDP 100 includes a front panel 1 and a back panel 8. A discharge space 14 is formed between the front panel 1 and the back panel 8. The PDP is a surface discharge AC-PDP having a structure similar to the structure of a conventional PDP, except that the above-described electron emission material is disposed on the protective layer.

The front panel 1 includes a front glass substrate 2; display electrodes 5, formed by transparent conductive films 3 and bus electrodes 4 and provided on an inner surface (on a surface facing the discharge space 14) of the front glass substrate 2; a dielectric layer 6 provided so as to cover the display electrodes 5; and a protective layer 7 provided on the dielectric layer 6. Each display electrode 5 is formed such that a bus electrode 4 made of Ag or the like for ensuring high conductivity is laminated to a transparent conductive film 3 made of ITO or tin oxide.

The back panel 8 includes a back glass substrate 9; address electrodes 10 provided on one surface of the back glass substrate 9; a dielectric layer 11 provided so as to cover the address electrodes 10; barrier ribs 12 provided on an upper surface of the dielectric layer 11; and phosphor layers 13 of different colors provided between the barrier ribs 12. The phosphor layers 13 of different colors are a red phosphor layer 13 (R), a green phosphor layer 13 (G), and a blue phosphor layer 13 (B) arranged in this order.

Examples of phosphors that constitute the phosphor layer 13 include BaMgAl₁₀O₁₇:Eu as blue phosphors, Zn₂SiO₄:Mn as green phosphors, and Y₂O₃:Eu as red phosphors.

The front panel 1 and the back panel 8 are joined using a sealing member (not illustrated) such that longitudinal directions of the display electrodes 5 are orthogonal to longitudinal directions of the address electrodes 10, and the display electrodes 5 and the address electrodes 10 face each other.

A discharge gas that is composed of rare gas components such as He, Xe or Ne is enclosed in the discharge space 14.

The display electrodes 5 and the address electrodes 10 are connected to an external drive circuit (not shown in the figures). Discharge occurs in the discharge space 14 due to voltage being applied across the drive circuit, and the phosphor layer 13 is excited to emit visible light by short wavelength ultraviolet light (147 nm wavelength) that is generated by the discharge.

By forming the protective layer 7 in the PDP 100 with the above-described electron emission material, the electron emission material faces the discharge space 14 and achieves the advantageous effect of reducing driving voltage.

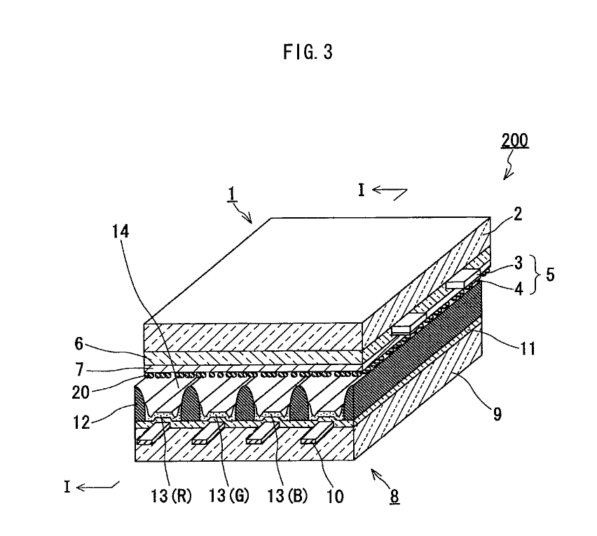

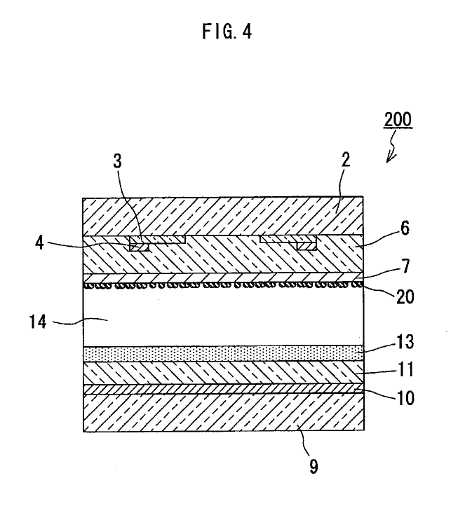

FIGS. 3 and 4 show a PDP 200 according to Embodiment 2.

FIG. 3 is an exploded perspective view of the PDP 200, and FIG. 4 is a longitudinal cross-section diagram of the PDP 200 (a cross-section diagram taken along the line I-I in FIG. 3).

The PDP 200 has the same structure as the PDP 100, except that the protective layer 7 is formed from MgO, and particles of the above-described electron emission material are disposed on the protective layer 7 to form an electron emission layer 20.

The PDP 200 also achieves the advantageous effect of reducing driving voltage, since the electron emission layer 20 faces the discharge space 14.

Note that the PDP provided with the electron emission material according to the present invention is not limited to a surface discharge PDP, but may also be an opposed discharge PDP. Furthermore, the present invention is not limited to a PDP provided with a front plate, a back plate, and barrier ribs, but includes any PDP that emits light by causing discharge in a discharge space by applying voltage between electrodes and causing phosphors to emit visible light by the discharge. For example, in a PDP that has an array of discharge tubes provided with phosphors therein and emits light by causing a discharge in each discharge tube, driving voltage may be reduced by providing the electron emission material in each discharge tube.

### (Method of Manufacturing a PDP)

The method of manufacturing a PDP is first described for a PDP in which an MgO film is provided as the protective layer 7 and a powder of the electron emission material is provided thereon, as in the PDP 200.

First, a front plate is produced.

During this process, a plurality of linear, transparent electrodes are formed on one major surface of a flat front glass substrate. After a silver paste is applied to the transparent electrodes, the entire front glass substrate is heated to bake the silver paste, thus forming the display electrodes 5.

A glass paste that includes glass for the dielectric layer is applied to the major surface of the front glass substrate 2 by a blade coater method so as to cover the display electrodes. The entire front glass substrate 2 is then held at 90° C. for 30 minutes to dry the glass paste and subsequently baked at approximately 580° C. for 10 minutes.

A magnesium oxide (MgO) film is formed on the dielectric layer 6 by an electron beam deposition method and baked to form the protective layer 7. The temperature during this baking is approximately 500° C.

The electron emission material in powder form is mixed with a vehicle such as ethyl cellulose to form a paste. The paste is applied to the protective layer 7 by the printing method or the like, dried, and baked at a temperature of approximately 500° C. to form the electron emission layer 20.

Next, a back plate is produced.

During this process, after silver pastes are applied in lines to one major surface of the flat back glass substrate, the entire back glass substrate is heated to bake the silver pastes, thus forming the address electrodes.

After glass pastes are applied between adjacent address electrodes, the entire back glass substrate is heated to bake the glass pastes, thus forming the barrier ribs.

Phosphor inks of colors of R, G and B are applied between adjacent barrier ribs. The back glass substrate is then heated at approximately 500° C. to bake the phosphor inks and to eliminate resin components (binders) and the like in the phosphor inks, thus forming the phosphor layer.

The front and back plates thus obtained are then sealed together with use of sealing glass. The temperature during sealing is approximately 500° C.

Thereafter, the inside of the sealed plates is evacuated to a high vacuum and then filled with a rare gas. This concludes the method of manufacturing the PDP.

Alternatively, as in the PDP 100, a protective layer 7 may be formed on the dielectric layer 6 from the electron emission material via a regular thin-film process, such as the electron beam deposition or the like used to form the MgO protective layer.

It is also possible to form a thin film or a thick film of the electron emission material by mixing a powder of the electron emission material with a vehicle, solvent, etc. to form a paste with a relatively high powder content, spreading the paste thinly on the dielectric layer 6 via the printing method or the like, and baking the paste.

Methods of dispersing the powder of the electron emission material on the dielectric layer 6 to form the protective layer 7 include a printing method using a paste with a relatively low powder content, dispersing a solvent in which the powder is dissolved, and using a spin-coater or the like.

Note that the above-described PDP structures and method of manufacturing are simply examples, and the present invention is not limited to the structure and method of manufacturing described above.

### EXAMPLES

The following describes the present invention in further detail based on examples.

### Example 1

As example 1, an experiment was performed to react CaO, SrO, BaO, and rare earth metal oxides with In₂O₃ by the solid phase reaction method, thereby synthesizing electron emission material (in crystalline compound form), in order to verify improvement in chemical stability.

### (Synthesis of Crystalline Compound)

The starting materials used were guaranteed reagent grade or higher CaCO₃, SrCO₃, and BaCO₃; La₂O₃ and Y₂O₃ as representative rare earth metal oxides; and In₂O₃. After these materials were weighed so that the molar ratios of the metal ions were the values in Table 1, the materials were wet blended with use of a ball mill and dried to obtain mixed powders. However, since No. 6 contained only In₂O₃, no wet blending was performed, nor was the below-described baking.

Each of the obtained mixed powders was placed into an aluminum crucible and baked in the air at 1000° C. to 1300° C. for two hours in an electric furnace. After an average particle size of each of the baked mixed powders was measured, particles having a large particle size were wet ball milled using dehydrated ethanol as a solvent. The average particle size was thus set to be approximately 3 μm in all compositions.

A formation phase was identified by analyzing a part of the milled powder via X-ray diffractometry.

### (Measurement of Weight Increasing Rate)

Next, after a part of the milled powder was weighed, the weighed powder was filled into a non-hygroscopic porous cell. The cell was then placed in a constant temperature and moisture chamber at a temperature of 35° C. and at 60% humidity for 12 hours. Subsequently, the cell was further placed in a constant temperature and moisture chamber at a temperature of 65° C. and at 80% humidity for twelve hours. The part of the milled powder was then weighed again to calculate a weight increasing rate (an integrated value). As the weight increasing rate grows lower, the compound becomes more chemically stable. For some samples, measurement using X-ray diffractometry was performed after the treatment in the constant temperature and moisture chamber. Furthermore, for the sake of comparison, an MgO powder was used as sample No. 16, and the weight increasing rate was measured in the same way.

TABLE 1

| | | | | | | | | Weight | | |
|---|---|---|---|---|---|---|---|---|---|---|
| | | | | | | | | increasing rate | | Working |
| | Composition ratio (at %) | | | | | | | (wt %) | | Example (WE) |
| | | | | Rare | | | Formation phase | 35° C., | +65° C., | or Comparative |
| No. | Ca | Sr | Ba | earth | In | Other | (XRD) | 60% | 80% | Example (CE) |
| 1 | 100 | | | | | | CaO | 36.5 | — | CE |
| 2 | | 100 | | | | | SrO + Sr(OH)₂ | 34.3 | — | CE |
| 3 | | | 100 | | | | Ba(OH)₂ + BaCO₃ | — | — | CE |
| 4 | | | | La = 100 | | | La₂O₃ | 1.8 | 4.5 | CE |
| 5 | | | | Y = 100 | | | Y₂O₃ | 0.3 | 1.2 | CE |
| 6 | | | | | 100 | | In₂O₃ | 0.0 | 0.1 | CE |
| 7 | 33.3 | | | | 66.6 | | CaIn₂O₄ | 0.0 | 0.0 | WE |
| 8 | | 33.3 | | | 66.6 | | SrIn₂O₄ | 0.0 | 0.0 | WE |
| 9 | | | 33.3 | | 66.6 | | BaIn₂O₄ | 0.1 | 0.2 | WE |
| 10 | | | | La = 50 | 50 | | LaInO₃ | 0.0 | 0.0 | WE |
| 10a | | 5 | | La = 45 | 50 | | (La,Sr)InOx | 0.0 | 0.1 | WE |
| 10b | 5 | | | La = 45 | 50 | | (La,Ca)InOx | 0.0 | 0.1 | WE |
| 11 | | | | Y = 50 | 50 | | YInO₃ | 0.0 | 0.0 | WE |
| 12 | | 50 | | | 25 | Nb = | Sr(In_{1/2}Nb_{1/2})O₃ | 0.0 | 0.0 | WE |
| | | | | | | 25 | | | | |
| 13 | | 50 | | | 25 | Ta = 25 | Sr(In_{1/2}Ta_{1/2})O₃ | 0.0 | 0.0 | WE |
| 14 | | | 50 | | 25 | Nb = | Ba(In_{1/2}Nb_{1/2})O₃ | 0.0 | 0.0 | WE |
| | | | | | | 25 | | | | |
| 15 | | | 50 | | 25 | Ta = 25 | Ba(In_{1/2}Ta_{1/2})O₃ | 0.0 | 0.0 | WE |
| 16 | | | | | | MgO = | MgO | 0.0 | 0.8 | CE |
| | | | | | | 100 | | | | |

### (Discussion of Experiment Results)

As shown in Table 1, analysis via X-ray diffractometry of the formation phase of samples No. 1-5, in which In is not present, indicates formation of CaO in sample No. 1, whereas in No. 2, Sr(OH)₂ is partially mixed with SrO. Sample No. 3 was a mixture of Ba(OH)₂ and BaCO₃, without the presence of BaO. The reason for such results is that SrO is less chemically stable than CaO, and furthermore BaO is less chemically stable than SrO. Therefore, it is considered that SrO and BaO reacted with moisture and carbon dioxide in the air during cooling after baking, consequently producing hydroxide and carbonate.

Since BaO was not observed in sample No. 3, it was obvious that sample No. 3 was the least stable. Accordingly, measurement of the weight increasing rate of sample No. 3 after treatment in the constant temperature and moisture chamber was not performed. On the other hand, formation of the intended crystalline compounds was observed in samples No. 4-15.

Next, measurement of the weight increasing rate after the treatment in the constant temperature and moisture chamber indicated that, even at a temperature of 35° C. and at 60% humidity for 12 hours, the weight increasing rate of CaO in sample No. 1 and SrO in sample No. 2 was very high. Furthermore, X-ray diffraction of these samples after the treatment revealed that a diffraction peak of an oxide had disappeared and hydroxide and carbonate had formed. Accordingly, it was clear that these samples are unstable, and further treatment at 65° C. and 80% humidity for 12 hours was not performed. Furthermore, while samples No. 4 and 5, which are comparative examples, have a much smaller weight increasing rate than samples No. 1-3, they still had a clearly larger weight increasing rate than sample No. 16, i.e. MgO.

On the other hand, the working examples, i.e. samples No. 7-15, were much more stable than samples No. 1-5, despite partial inclusion of Ca, Sr, Br, and/or a rare earth metal. Furthermore, samples No. 7-15 had a smaller weight increasing rate than sample No. 16, i.e. MgO, and only indicated the corresponding diffraction peak during X-ray diffraction after treatment. The advantageous effect of stability due to formation of the compounds was thus confirmed. The (M1₁₋ₓM2ₓ)InO₃-δ compound in samples No. 10a and 10b were acquired by partially substituting the La in the MInO₃ compound of sample No. 10 respectively with Sr and Ca. The resulting crystal structure was the same as sample No. 10, and a similar advantageous effect of stability was achieved. The upper limit for the amount of the La element replaced by Sr or Ca was 10% based on examination by the inventors and others.

The inventors and others performed a similar experiment on an oxide of each rare earth metal other than La and Y. Stability due to formation of a compound by reacting the oxides with In₂O₃ was confirmed in all cases.

### (Manufacturing of PDP and Measurement of Discharge Voltage)

PDPs were manufactured as below using the crystalline compounds in the above working examples and comparative examples, and discharge voltage was measured.

A flat front glass substrate that had a thickness of about 2.8 mm and was made of soda lime glass was prepared. ITO (a material for a transparent electrode) was applied to a surface of the front glass substrate in a predetermined pattern and dried. Next, silver paste that was a mixture of a silver powder and an organic vehicle was applied in lines. The front glass substrate was then heated to bake the silver paste, thus forming the display electrodes.

A glass paste was applied by a blade coater method to a front panel on which the display electrodes were formed. The glass paste was dried by being held at 90° C. for 30 minutes, and then baked at 585° C. for 10 minutes to form a dielectric layer having a thickness of approximately 30 μm.

After magnesium oxide (MgO) was deposited on the dielectric layer by an electron beam deposition method, a protective layer was formed by baking the deposited magnesium oxide at 500° C. Next, approximately three parts by weight of a powder of each of the following compounds from Table 1 were mixed with 100 parts by weight of an ethyl cellulosic vehicle, the mixture was milled by using a triple roll mill to form a paste, and a thin layer of the paste was applied to the MgO layer by a printing method, dried at 90° C., and baked in the air at 500° C. Compounds of the comparative examples were compounds of samples No. 1-4 and 6, and compounds according to the present invention were a compound of sample No. 8 as a representative of an MIn₂O₄ compound, a compound of sample No. 10 as a representative of an MInO₃ compound, a compound of sample No. 10a as a representative of an (M1₁₋ₓM2ₓ)InO₃-δ compound, and a compound of sample No. 14 as a representative of an M1(In_{1/2}M2_{1/2})O₃ compound. During this process, a ratio at which the MgO layer was covered with a powder (covering rate) after the baking was adjusted to be approximately under 20% by controlling the concentration of the paste. For comparison, a PDP was manufactured without printing a paste thereon.

A back plate was produced in the following manner.

First, address electrodes that were mainly made of silver were formed in stripes on a back glass substrate made of soda lime glass by screen printing. A dielectric layer having a thickness of approximately 8 μm was then formed in a manner similar to the manner to form the dielectric layer on the front plate.

Next, barrier ribs were formed between adjacent address electrodes on the dielectric layer with use of glass pastes. The barrier ribs were formed by repeatedly performing screen printing and baking.

Red (R), green (G) and blue (B) phosphor pastes were then applied to walls of the barrier ribs and exposed surfaces of the dielectric layer between barrier ribs, dried out, and baked to produce a phosphor layer.

The produced front plate and back plate were sealed together at 500° C. with use of a sealing glass. After the air was evacuated from a discharge space, Xe was enclosed in the discharge space as a discharge gas, thereby completing production of the PDP.

Each of the produced PDPs was aged by being connected to a drive circuit and caused to emit light continually for 100 hours, after which discharge sustaining voltage was measured. In this context, the aging processing was performed in order to clean surfaces of the MgO film and dispersed powders to some extent by sputtering. The aging processing is commonly performed in a manufacturing process of a PDP. When the aging processing is not performed, discharge voltage of the PDP becomes high regardless of whether powders are dispersed.

Table 2 shows measurement results of discharge voltage (driving voltage) after aging. Note that No. 0 is the result for a PDP with only an underlying film of MgO, i.e. without powder dispersed thereon. The “Difference in voltage with underlying film” is the difference between the driving voltage of each No. and the driving voltage of No. 0.

TABLE 2

| | | | | | | | | Driving voltage | | |
|---|---|---|---|---|---|---|---|---|---|---|
| | | | | | | | | | Difference | |
| | | | | | | | | | in voltage | |
| | Composition ratio (at %) | | | | | | | | with | |
| | | | | Rare | | | Formation phase | | underlying | WE/ |
| No. | Ca | Sr | Ba | earth | In | Other | (XRD) | Voltage | film | CE |
| 0 | | | | | | Mg = 100 | Underlying film | 249 V | — | CE |
| 1 | 100 | | | | | | CaO | 257 V | +8 V | CE |
| 2 | | 100 | | | | | SrO + Sr(OH)₂ | 254 V | +5 V | CE |
| 3 | | | 100 | | | | Ba(OH)₂ + BaCO₃ | 252 V | +3 V | CE |
| 4 | | | | La = 100 | | | La₂O₃ | 251 V | +2 V | CE |
| 6 | | | | | 100 | | In₂O₃ | >280 V | >31 V | CE |
| 8 | | 33.3 | | | 66.6 | | SrIn₂O₄ | 225 V | −24 V | WE |
| 10 | | | | La = 50 | 50 | | LaInO₃ | 230 V | −19 V | WE |
| 10a | | 5 | | La = 45 | 50 | | (La,Sr)InOx | 226 V | −23 V | WE |
| 14 | | | 50 | | 25 | Nb = 25 | Ba(In_{1/2}Nb_{1/2})O₃ | 234 V | −15 V | WE |

### (Discussion Based on Measurement Results of Discharge Voltage)

In the PDPs according to the comparative examples in which the powders of samples No. 1-4 were dispersed, no decrease in discharge voltage was observed as compared to sample No. 0, in which only a thin MgO film was formed. For an unknown reason, the PDP of sample No. 6, a comparative example in which an In₂O₃ powder was dispersed, stopped emitting light during the aging process.

On the other hand, in the working example PDP, in which the powders of samples No. 8, 10, 10a, and 14 were respectively dispersed, a decrease in discharge voltage was observed in every PDP. The decrease in discharge voltage was particularly significant in PDP No. 8, which had SrIn₂O₄ dispersed therein. The improvements achieved by the present invention were thus confirmed. Furthermore, partially replacing the La of No. 10 to yield No. 10a caused a greater decrease in voltage.

### INDUSTRIAL APPLICABILITY

The present invention improves discharge characteristics and lowers driving voltage of a PDP and is therefore useful in achieving a PDP that operates with low power consumption.

### REFERENCE SIGNS LIST

1 front panel
2 front glass substrate
3 transparent conductive film
4 bus electrode
5 display electrode
6 dielectric layer
7 protective layer
8 back panel
9 back glass substrate
10 address electrode
11 dielectric layer
12 barrier rib
13 phosphor layer
14 discharge space
20 electron emission layer

1. A plasma display panel that emits light, includes electrodes and phosphors, encloses a discharge space, causes discharge in the discharge space by applying voltage between the electrodes, and causes the phosphors to emit visible light by the discharge, wherein
a region of the plasma display panel facing the discharge space has disposed thereon a crystalline material formed from a compound selected from the group consisting of:
(i) MIn₂O₄, M being one or more selected from the group consisting of Ca, Sr, and Ba;
(ii) MInO₃, M being one or more rare earth metal;
(iii) (M1₁₋ₓM2ₓ)InO₃-δ, M1 being one or more rare earth metal, M2 being one or more selected from the group consisting of Sr and Ca, and x satisfying the relationship 0<x≦0.1; and
(iv) M1(In_{1/2}M2_{1/2})O₃, M1 being one or more selected from the group consisting of Ca, Sr, and Ba, and M2 being one or more selected from the group consisting of Nb and Ta.

2.-6. (canceled)

7. The plasma display panel of claim 1, comprising:
a first panel and a second panel opposing each other, the first panel including a first substrate, a first electrode disposed thereon, and a first dielectric layer covering the first electrode, the second panel including a second substrate, a second electrode disposed thereon, and a second dielectric layer covering the second electrode; and
a phosphor layer disposed on the second dielectric layer, wherein
the discharge space is between the first panel and the second panel.

8. The plasma display panel of claim 7, wherein the crystalline material is disposed in at least one of (i) particulate form and (ii) the form of a film.

9. The plasma display panel of claim 7, wherein the crystalline material is disposed on at least one of the first panel and the second panel.

10. The plasma display panel of claim 7, wherein a protective layer is formed on the first dielectric layer.

11. The plasma display panel of claim 10, wherein a primary component of the protective layer is MgO.

12. The plasma display panel of claim 10, wherein the crystalline material is disposed on the protective layer.

13. The plasma display panel of claim 10, wherein the crystalline material is included in the protective layer.
